(19) United States
(12) Patent Application Publication
(10) Pub. No.: US 2018/0117553 A1
(43) Pub. Date: May 3, 2018

(54) LABORATORY DEVICE

(71) Applicant: HANS HEIDOLPH GMBH & CO. KG, Kelheim (DE)

(72) Inventor: Walter Lohmann, Wendelstein (DE)

(73) Assignee: HANS HEIDOLPH GMBH & CO. KG, Kelheim (DE)

(21) Appl. No.: 15/536,646

(22) PCT Filed: Dec. 16, 2015
(86) PCT No.: PCT/EP2015/080037

§ 371 Date: Jun. 16, 2017

(30) Foreign Application Priority Data
Dec. 17, 2014 (DE) 10 2014 118 852.7

(51) Int. Cl. B01F 15/06; G01G 17/04; G01K 13/00; B01F 13/08; B01F 15/00; H05B 3/68

(52) U.S. Cl. CPC B01F 15/065; G01G 17/04; G01K 13/00; B01F 13/0818; B01F 2015/062; B01F 15/00175; B01F 15/00396; H05B 3/68; B01F 15/00194

(57) ABSTRACT

The invention relates to a laboratory device, in particular to a magnetic stirrer, having a heating unit for heating a medium, in particular a liquid, in a container, and having a regulating unit that is configured to regulate the temperature of the medium, of the heating unit and/or of the container by controlling the heating power of the heating unit, wherein a weight determination unit is provided to determine the weight of the medium, and wherein the regulation of the temperature takes place in dependence on the weight determined.

The invention relates to a laboratory device, in particular to a magnetic stirrer, having a heating unit for heating a medium, in particular a liquid, in a container and having a regulating unit that is configured to regulate the temperature of the medium, of the heating unit and/or of the container by controlling the heating power of the heating unit.

Such laboratory devices are generally known. Magnetic stirrers can thus be equipped with a hot plate in order also to simultaneously heat a medium during the mixing, for example to a temperature of up to 300° C. The revolution speeds during the mixing can amount to 30 to 1400 r.p.m., for example. A container having a medium can be placed onto the heating unit whose power can e.g. amount to up to 800 watts. The container, in particular a beaker or an Erlenmeyer flask, can essentially be dimensioned in any desired size and can, for example, have a capacity of 50 ml, 100 ml, 250 ml, 500 ml, 750 ml, 1 L, 5 L, 10 L or 20 L. The laboratory device can also be a rotary evaporator or a large rotary evaporator, for example. The flask size of an associated evaporator flask can in this respect amount to up to 5 L or up to 20 L, for example.

The regulation of the temperature takes place using temperature data that are determined by at least one temperature probe. For example, with a magnetic stirrer, two temperature probes can be provided in the medium and/or two temperature probes can be provided in the hot plate. One temperature probe in this respect serves as a control sensor, while the additional probe acts as a redundant plausibility probe.

With known magnetic stirrers, the heating unit is initially operated at full power, e.g. at 800 watts, to determine whether a large or small volume of the medium is in the container and thus whether a higher or smaller heating power is generally required. In this respect, the temperature increase of the liquid can be determined within a specific time period, e.g. 10 seconds. Since the temperature increase is generally the larger, the less medium is in the container, an estimate can be made from the temperature increase or from the temperature gradient as to what volume of the medium is located in the container. The volume estimated in this manner can then enter into the heating power or the regulation of the temperature as a parameter. A lower volume in particular has to be heated less than a larger volume to reach the same temperature within the same time period.

The determination of the volume of the medium using the temperature increase or the temperature gradient is, however, comparatively inaccurate so that it can occur that the heating power is set such that there is either too little or too much heat and, accordingly, the heating either takes too long or temperature overshoots occur.

It is therefore an object of the invention to provide a laboratory device with which the heating of a medium can be improved in a simple manner.

This object is satisfied by an apparatus and by a method having the features of the respective independent claim.

In accordance with the invention, a weight determination unit is provided for determining the weight of the medium, wherein the regulation of the temperature in particular takes place by a corresponding control of the heating power of the heating unit in dependence on the weight determined.

As can be seen from the wording of independent claim 1, the container is not a compulsory component of the claimed laboratory device. The laboratory device can nevertheless also comprise a container. Alternatively and/or additionally, protection is also claimed for a system comprising a laboratory device in accordance with the invention and a container for receiving a liquid heatable by the heating unit of the laboratory device, in particular for the case that the container has a temperature sensor to regulate the temperature of the container.

In accordance with the invention, the weight of a medium can be determined and can be used as a parameter for the heating power or for regulating the temperature. This is substantially more exact than a volume determination with the aid of a temperature increase caused by a defined heating pulse at the start of the heating procedure such as is known from the prior art.

The weight data can in particular enter into the regulation of the temperature without being visually displayed. Alternatively, however, a visual display of the weight for a user is conceivable.

The regulated temperature can be the temperature of the medium, the temperature of the heating unit or the temperature of the container, i.e. the temperature of the medium can be regulated both directly and indirectly via the regulation of the temperature of the heating unit or of the container.

To take account of the weight of the container in the determination of the weight of the medium, the container can first be weighed without medium. The weight determination unit can in this respect be calibrated or set. For example, either an empty container can first be placed on the heating device and subsequently filled with a medium or a container filled with medium can be placed directly on the heating apparatus. The weight of the medium is thereupon determined. If a high weight is present, the heating must be correspondingly higher with respect to a lower weight.

The regulating unit inter alia controls the heating power of the heating unit using the acquired weight data. The control of the heating unit can in particular take place via pulse width modulation or can be configured as an analog control. The heating unit can in particular be configured as a resistance heater. The heating unit can preferably comprise a hot plate on which the container is placed.

The weight can, for example, be determined once at the start of a mixing and/or heating procedure. This is in particular sufficient when the weight substantially remains constant during the mixing or heating procedure. If, however, evaporation and thus changes of the weight of the medium can occur, the weight can also be determined consecutively, i.e. continuously, or at specific time intervals. The newly determined weight data can be reported to the regulating unit to adapt the heating power accordingly using these parameters. Such a procedure can also be sensible if the medium is topped up.

Further developments of the invention can also be seen from the dependent claims, from the further description and from the enclosed drawing.

In accordance with an embodiment, the weight determination unit comprises a load cell, in particular a spring body provided with a strain gauge. However all apparatus are generally conceivable as weight determination units that are suited to determine the weight of the medium.

In accordance with a further embodiment, the weight determination unit, in particular the load cell, is arranged between the heating unit that is in particular configured as a hot plate and a device body of the laboratory device. Feet can in particular be attached to the device body, for example to position the laboratory device on a laboratory bench. The device body can in particular comprise the regulating unit. Since the weight determination unit is arranged between the heating unit and the device body, the entire weight of the laboratory device is not borne by the weight determination unit, but only the weight of the hot plate, of the container and of the medium.

The laboratory device in accordance with the invention and/or a system that comprises the laboratory device in accordance with the invention comprises/comprise at least one temperature probe for determining the temperature of the heating unit, of the container and/or of the medium. The at least one temperature probe can be integrated in the heating unit, can be integrated in the container and/or can be immersible in the medium. In the event that the temperature probe is integrated in the heating unit, the at least one temperature probe is preferably a component of the laboratory device. In the event that the temperature probe is integrated in the container, the at least one temperature probe is preferably a component of the laboratory device or of a system that comprises the laboratory device in accordance with the invention and the container. In the event that the temperature probe is immersible in the medium, the at least one temperature probe is preferably a component of a system that comprises the laboratory device in accordance with the invention and the at least one temperature probe. At least two temperature probes can in particular also be provided, in particular a control sensor and a redundant plausibility probe. Errors in the temperature measurement can be simply recognized in this manner. If a temperature probe is integrated in the heating unit, a respective threaded bore can be provided in the heating unit, for example, and the temperature probe can be introduced into it.

In accordance with a further embodiment, the laboratory device is configured such that the weight of the medium is determined at the start of the temperature regulation, in particular before the start of the temperature regulation, and the heating power, in particular at least the initial heating power, is set in dependence on the weight determined at the start of the temperature regulation. A single weight determination only at the start of the temperature regulation can in particular be provided if the weight of the medium does not change during the mixing or heating procedure. Alternatively, the weight can be determined continuously and can be reported to the regulating unit to adapt the heating power accordingly on a change of the weight.

In accordance with a further embodiment, the regulating unit is configured such that the heating power of the heating unit is controlled such that a temperature increase of the heating unit and/or of the container per time unit does not exceed a predefined maximum permitted value. A specific temperature gradient may consequently not be exceeded in this case during heating. The heating should in particular not be greater than the heat that can be taken up by the container or by the medium. Provision can furthermore be made and/or can be made in this connection that the laboratory device switches off the heating unit, in particular to protect against overheating of container and/or of the heating unit if a set limit value of the temperature is exceeded.

The invention also relates to a method of operating a laboratory device, in particular of a magnetic stirrer, in which a medium, in particular a liquid, in a container is heated by means of a heating unit and the temperature of the medium, of the heating unit and/or of the container is regulated by means of a regulating unit by controlling the heating power of the heating unit. The weight of the medium is determined by means of a weight determination unit, with the temperature being regulated in dependence on the weight determined. The weight of the medium in the container is thus preferably first determined and the heating power of the heating unit is regulated in dependence on this parameter.

The temperature of the heating unit, of the container and/or of the medium is in particular determined by means of at least one temperature probe that is in particular integrated in the heating unit, is integrated in the container and/or is immersed in the medium.

In accordance with an embodiment, analog to the corresponding embodiment of the laboratory device in accordance with the invention, the weight of the medium is determined at the start of the temperature regulation and the heating power is set in dependence on the weight determined at the start of the temperature regulation. The weight data can, however, as already mentioned above, also be determined continuously and communicated to the regulating unit. The laboratory device can be configured such that the weight of the medium is determined continuously and the heating power is adapted accordingly on a change of the weight. In accordance with a further embodiment, analog to the corresponding embodiment of the laboratory device in accordance with the invention, the heating power of the heating unit is controlled such that a temperature increase of the heating unit and/or of the container per time unit does not exceed a predefined maximum permitted value.

All the embodiments of the apparatus described here are in particular configured to be operated in accordance with the method described here, and vice versa. Furthermore, all the embodiments of the apparatus described here as well as all the embodiments of the method described here can each be combined with one another.

The invention will be described in the following by way of example with reference to the drawing. There is shown:

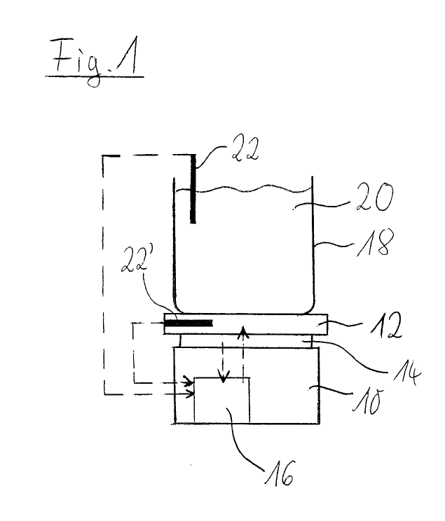

FIG. 1 a schematic representation of an embodiment of a laboratory device in accordance with the invention together with a container.

It is first stated that the embodiment shown is of a purely exemplary nature. The number and the position of the temperature probes shown can in particular vary as desired.

FIG. 1 shows a magnetic stirrer having a heating function, i.e. a heating stirrer, having a device body 10 and a hot plate 12. A container 18 that is filled with a liquid 20 to be heated by means of the hot plate 12 is arranged on the hot plate 12. A magnetic stirrer, not shown, is located in the liquid 20 and is set into a rotating movement mixing the liquid 20 in a known manner by a rotating magnet, not shown, arranged in the device body 10.

A temperature probe 22 is provided to regulate the temperature of the liquid 20 and is immersed into the liquid 20 to determine the temperature of the liquid 20. The determined temperature is fed back to a regulating unit 16 that is arranged in the device body 10 and that controls the heating power of the hot plate 12. The liquid 20 can, for example, first be brought to a predefined temperature by means of the temperature regulation and can then be held at the predefined temperature.

A second temperature probe 22′ is furthermore provided that is integrated in the hot plate 12. The temperature of the hot plate 12 that is reported to the regulating unit 16 can be monitored by means of the second temperature probe 22*. On an exceeding of a predefined temperature threshold value, the hot plate 12 can be switched off by the regulating unit 16 or the heating power can be correspondingly reduced to avoid an overheating and thus possible damage to the hot plate 12. It is generally also conceivable to regulate the temperature of the liquid 20 indirectly via the temperature determined by the second temperature probe 22′. The first temperature probe 22 can then be dispensed with.

A weight determination unit 14 is furthermore provided that is arranged between the hot plate 12 and the device body 10 to determine the weight of the liquid 20 at the start of the temperature regulation. The weight determination unit 14 can, for example, be a load cell. The weight of the liquid 20 is forwarded to the regulating unit 16. The weight determined can then enter into the regulation of the temperature of the liquid 20. This is of advantage since more energy is required to heat a larger quantity of liquid than to heat a quantity of liquid small in relation thereto. The heating power can accordingly be selected the higher, the greater the weight of the liquid 20.

To determine the weight of the liquid 20, for example, the weight of the container 18 alone can be determined, on the one hand, and the joint weight of the container 18 and of the liquid 20 can be determined, on the other hand, and the weight of the liquid 20 can be determined from this difference. Alternatively, the weight of the container 18 can also be known to the magnetic stirrer or can be manually input into the magnetic stirrer so that a separate weight determination for the container 18 is not necessary.

The weight of the liquid 20 can be determined once at the start of the temperature regulation such as has been explained above. Alternatively, however, it is also possible to determine the weight continuously, in particular when some of the liquid has evaporated 20 or when liquid is topped up. In this case, the heating power can be correspondingly readjusted or adapted in dependence on the changing weight data.

### REFERENCE NUMERAL LIST

10 device body
12 hot plate, heating unit
14 weight determination unit
16 regulating unit
18 container
20 liquid, medium
22, 22′ temperature probe

1-10. (canceled)

11. A laboratory device, comprising
a heating unit for heating a medium in a container;
a regulating unit that is configured to regulate at least one of a temperature of the medium,
a temperature of the heating unit and a temperature of the container by controlling a heating power of the heating unit; and
a weight determination unit for determining the weight of the medium;
wherein the regulation of the temperature takes place in dependence on the determined weight.

12. The laboratory device in accordance with claim 11, wherein the laboratory device is a magnetic stirrer.

13. The laboratory device in accordance with claim 11, wherein the medium is a liquid.

14. The laboratory device in accordance with claim 11, wherein the weight determination unit comprises a load cell.

15. The laboratory device in accordance with claim 11, wherein the weight determination unit is arranged between the heating unit and a device body of the laboratory device.

16. The laboratory device in accordance with claim 15, wherein the heating unit is configured as a hot plate.

17. The laboratory device in accordance with claim 11, further comprising at least one temperature probe that is integrated in the heating unit to determine the temperature of the heating unit.

18. The laboratory device in accordance with claim 11, wherein the laboratory device is configured such that the weight of the medium is determined at the start of the temperature regulation and the heating power is set in dependence on the weight determined at the start of the temperature regulation.

19. The laboratory device in accordance with claim 11, wherein the laboratory device is configured such that the weight of the medium is determined continuously and the heating power is adapted accordingly on a change of the weight.

20. The laboratory device in accordance with claim 11, wherein the regulating unit is configured such that the heating power of the heating unit is controlled such that a temperature increase of the heating unit and/or of the container per time unit and/or an absolute temperature of the heating unit and/or of the container does not exceed a respective predefined maximum permitted value.

21. A method of operating a laboratory device, the method comprising the steps of:
heating a medium in a container by means of a heating unit;
regulating at least one of a temperature of the medium, a temperature of the heating unit and a temperature of the container by means of a regulating unit by controlling the heating power of the heating unit; and
determining a weight of the medium by means of a weight determination unit;
wherein the temperature is regulated in dependence on the determined weight.

22. The method in accordance with claim 21, wherein the laboratory device comprises the heating unit, the regulating unit and the weight determination unit.

23. The method in accordance with claim 21, wherein the medium is a liquid.

24. The method in accordance with claim 21, further comprising the step of: determining at least one of the temperature of the heating unit, the temperature of the container and the temperature of the medium by means of at least one temperature probe.

25. The method in accordance with claim 24, wherein the at least one temperature probe is integrated in the heating unit, in the container and/or is immersed in the medium.

26. The method in accordance with claim 21, wherein the weight of the medium is determined at the start of the temperature regulation and the heating power is set in dependence on the weight determined at the start of the temperature regulation.

27. The method in accordance with claim 21, wherein the laboratory device is configured such that the weight of the medium is determined continuously and the heating power is adapted accordingly on a change of the weight.

28. The method in accordance with claim 21, wherein the heating power of the heating unit is controlled such that a temperature increase of the heating unit and/or of the container per time unit and/or an absolute temperature of the heating unit and/or of the container does not exceed a respective predefined maximum permitted value.
